(19) United States
(12) Patent Application Publication
(10) Pub. No.: US 2012/0217735 A1
(43) Pub. Date: Aug. 30, 2012

(54) Indexed Book

(76) Inventor: Kelly Patrick Stephens, Winnipeg (CA)

(21) Appl. No.: 13/403,483

(22) Filed: Feb. 23, 2012

Related U.S. Application Data
(60) Provisional application No. 61/446,350, filed on Feb. 24, 2011.

(51) Int. Cl. B42D 5/00

(52) U.S. Cl. 281/38

(57) ABSTRACT

An indexed book of information bits has a hierarchal structure of primary headings and secondary headings within each primary heading. Each secondary heading includes a group of information bits associated therewith. The pages of the book are bound at first edges in a spine, include primary markings representing primary headings along second edges, and include secondary markings representing secondary headings along third edges. Indicating portions are provided along each of the second and third edges to associate each page with a respective primary heading and a respective secondary heading.

This application claims the benefit under 35 U.S.C. 119(e) of U.S. provisional application Ser. No. 61/446,350, filed Feb. 24, 2011.

### FIELD OF THE INVENTION

The present invention relates to a book including information bits indexed into a hierarchal structure including primary and secondary headings represented by respective markings on indicating formations on the side edges of the pages.

### BACKGROUND

Indexes for books are common in various forms for ease of locating information in the books. Various examples are disclosed in U.S. Pat. Nos. 4,291,900 by Feng, 3,754,778 by Lenahan, 433,233 by Wells and 955,735 by Wood. In each of the prior art indexes, primary and secondary headings are represented by tabbed formations typically along a common edge of the pages. This configuration limits the size of the index permitted while also causing some confusion for the user between the primary and secondary headings. Known indexes are also typically provided along a vertical side edge in relation to the text of the book such that the writing on the tabs must either be very narrow or oriented perpendicularly to the text on the pages to follow the length of the side edge which adds to the confusion in reading the index.

### SUMMARY OF THE INVENTION

According to one aspect of the invention there is provided an indexed book comprising:
a plurality of information bits organized into a hierarchal structure including a plurality of primary headings, each primary heading being subdivided into a plurality of secondary headings associated therewith, and each secondary heading including a respective group of the information bits associated therewith;
a plurality of pages comprising respective first edges bound in a common spine, respective second edges locating primary markings which represent respective ones of the primary headings, and respective third edges locating secondary markings at spaced positions therealong which represent respective ones of the secondary headings;
each page further comprising a plurality of the information bits thereon associated with one primary heading and one secondary heading;
the primary markings being arranged in at least one row in which each primary marking of said at least one row is spaced apart from the other primary markings of the row along the second edge;
each second edge further comprising an indicating portion in alignment with a respective one of the primary markings so as to associate the respective page with the respective primary heading;
the secondary markings of each primary marking being arranged in a respective row in which each secondary markings is spaced apart from the other secondary markings of the row along the third edge; and
each third edge further comprising an indicating portion in alignment with a respective one of the secondary markings so as to associate the respective page with the respective secondary heading.

By providing primary and secondary indexes along different edges, there is increased visual separation between the primary and secondary headings to reduce the confusion for the user while also permitting a larger number of index markings and separate tabbed formations as each of the primary and secondary headings are permitted to span a full length of a respective edge of the page. To increase the lateral space provided for markings relating to the primary and secondary headings, the primary index can be located along a bottom horizontal edge of the page or multiple rows of tabs can be provided so that the width of individual tabs within each row can be increased for maximizing the visual reference for the user. By locating the spine along the top edge for example, the primary headings can be located at an opposing bottom edge for quicker visual reference to more readily narrow down the user's search among the content of the book. The upper spine also allows the bottom and right sides of the book to be more readily used for indexed headings which is most accessible for right handed persons.

According to a second aspect of the present invention there is provided an indexed book comprising:
a plurality of information bits organized into a hierarchal structure including a plurality of primary headings, each primary heading being subdivided into a plurality of secondary headings associated therewith, and each secondary heading including a respective group of the information bits associated therewith;
a plurality of pages comprising respective first edges bound in a common spine, respective second edges locating primary markings which represent respective ones of the primary headings, and respective third edges locating secondary markings at spaced positions therealong which represent respective ones of the secondary headings;
the first edges comprising a top edge of the book, the second edges being opposite the first edges such that the primary headings are located along a bottom edge of the book, and the third edges being adjacent the first edges of the pages;
each page further comprising a plurality of the information bits thereon associated with one primary heading and one secondary heading;
the primary markings being arranged in a first row and in a second row in which each primary marking of each row is spaced apart from the other primary markings of the row along the second edge;
a first group of the pages being associated with the first row of the primary markings and having a first overall length from an opposing edge and a second group of the pages being associated with the second row of the primary markings and having a second overall length from the opposing edge which is greater than the first overall length;
each second edge further comprising an indicating portion in alignment with a respective one of the primary markings so as to associate the respective page with the respective primary heading;
each second edge further comprising a first portion at a first length from the opposing edge and a second portion having a second length from the opposing edge which is less than the first length such that the first and second portions meet at a shoulder formed on the second edge which defines the indicating portion associated with the respective primary heading;
the secondary markings of each primary marking being arranged in a respective row in which each secondary markings is spaced apart from the other secondary markings of the row along the third edge;
each third edge further comprising an indicating portion in alignment with a respective one of the secondary markings so as to associate the respective page with the respective secondary heading; and
each third edge further comprising a first portion at a first length from the opposing edge and a second portion having a second length from the opposing edge which is less than the first length such that the first and second portions meet at a shoulder formed on the third edge which defines the indicating portion associated with the respective secondary heading.

One embodiment of the invention will now be described in conjunction with the accompanying drawings in which:

### BRIEF DESCRIPTION OF THE DRAWINGS

FIG. 1 is a perspective view of the indexed book;

FIG. 2 is a top plan view of the indexed book;

FIG. 3 is an end elevational view of the indexed book; and

FIG. 4 is a side elevational view of the indexed book.

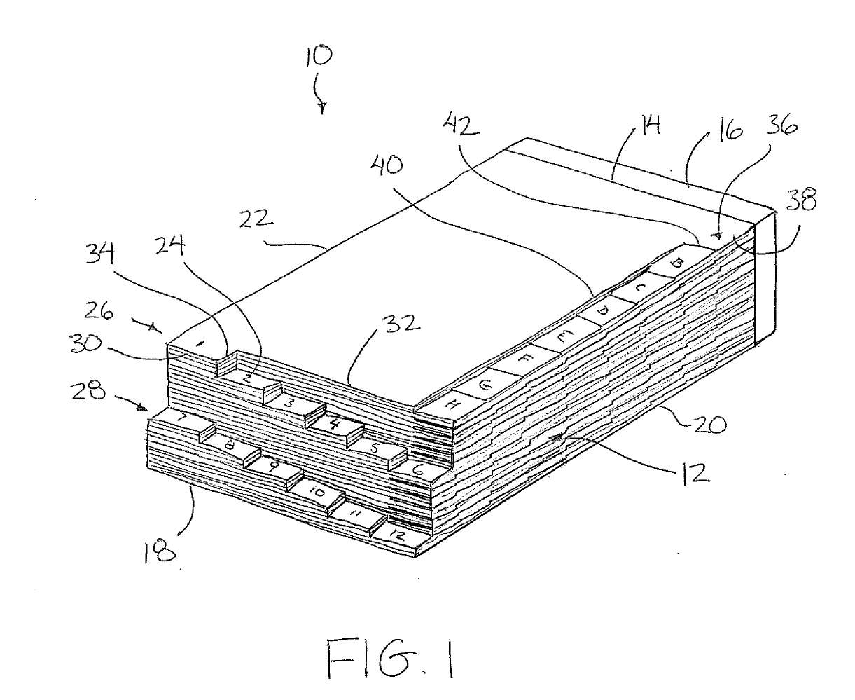

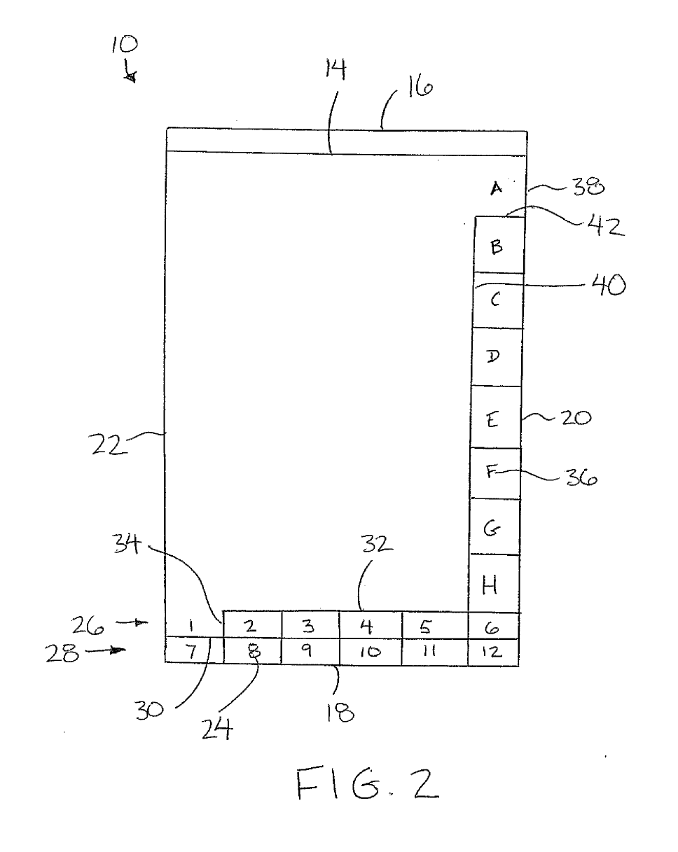

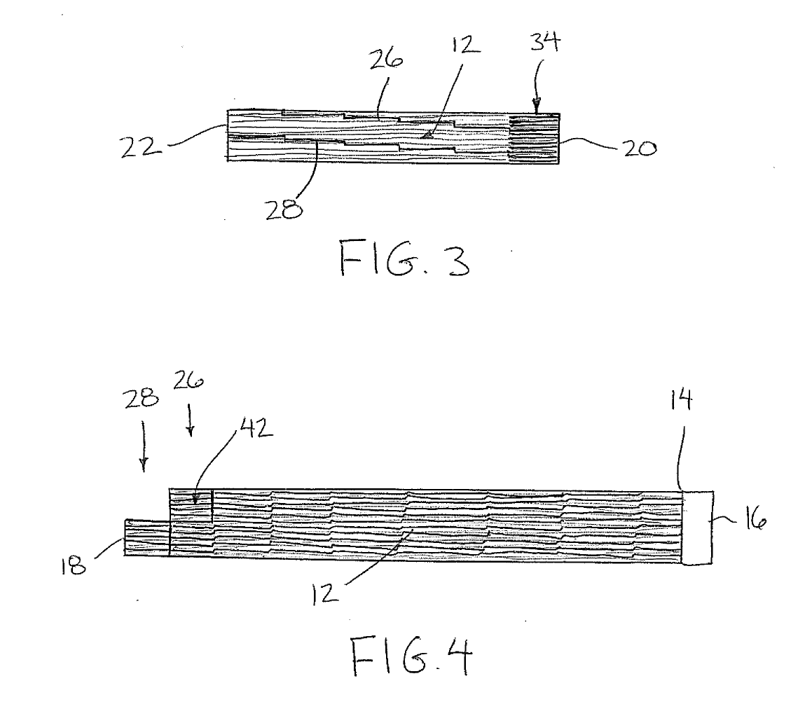

In the drawings like characters of reference indicate corresponding parts in the different figures.

### DETAILED DESCRIPTION

Referring to the accompanying figures there is illustrated an indexed book generally indicated by reference numeral 10. The book comprises a plurality of pages 12 each having a first top edge 14 bound in a common spine 16 of the book, and an opposing second bottom edge 18 opposite the common spine. Each page further comprises a third edge 20 extending along the right side of each page between the top and bottom sides as well as an opposing fourth edge 22 extending along the left side between the top and bottom ends. The fourth edge in the illustrated embodiment is a straight edge with no markings thereon.

Each page further includes a plurality of information bits printed thereon which have been organized into a hierarchal structure including primary headings which are each subdivided into secondary headings. The secondary headings are then subdivided into respective groups of information bits. Each page thus includes a respective group of bits belonging to one secondary heading and one primary heading to which the secondary heading is associated. Several pages may be associated with the same secondary heading with several groups of pages belonging to several secondary headings typically belonging to each primary heading.

The primary headings are represented by primary markings 24 provided along the bottom edges of the pages. In the illustrated embodiment the primary markings are represented by characters 1 through 12. The primary markings are typically arranged in a first row 26 and a second row 28 spanning laterally across the width of the book at the bottom end. A first group of the pages corresponding to the first half of the book closest to the front cover are represented by the first row 26 while a second half of the pages closest to the rear cover are represented by the second row 28. Within each row, each of the primary markings are spaced apart by other primary markings within the same row with the markings being provided in the continuing sequence from the left side to the right side of each row and with the second row following in sequence after the first row.

The first group of pages have a maximum overall length from the top edge in the common spine to the bottom edge which is less than a maximum overall length between top and bottom edges of the pages in the second group. The pages in the second group thus protrude downwardly beyond the pages in the first group so that the first and second rows of primary markings are simultaneously visible in the closed position of the pages.

The bottom edge of each page includes a first portion 30 having a first length from the opposing top edge and a second portion 32 having a second length from the opposing top edge which is less than the first length such that the first and second portions meet at an intermediate shoulder 34 formed on the second edge. The shoulder 34 defines an indicating portion which is aligned with all of the shoulders of the other pages within that same primary heading such that only the uppermost one of the pages of each primary heading is visible when the pages are in a closed position. The primary marking associated with that primary heading is located on the uppermost page adjacent to and in alignment with the indicating portion so as to be visible in the closed position of the pages.

The secondary headings are similarly represented by secondary markings 36 along the third edge of the pages. In the illustrated embodiment the secondary markings are represented by characters A through H. Each group of secondary headings associated with one of the primary headings comprises a full row of markings in sequence from the top edge to the bottom edge of the book. All of the pages have the same maximum overall width between left and right side edges such that all of the rows of secondary markings overlap one another in the closed position of the pages.

Similarly to the bottom edge, each right side edge or third edge 20 is also formed to have a first portion 38 having a first width from the opposing edge and a second portion 40 having a second width from the opposing edge which is less than the first width such that the first and second portions meet at a shoulder 42 formed on the third edge. On the third edge, the first portion is vertical between the shoulder and the top edge while the second portion is vertical between the shoulder and the bottom edge. This arrangement is similar to the second edge in which the first portion 30 is horizontal between the shoulder 34 and the left side edge while the second portion 32 is horizontal between the shoulder and the right side edge.

Each shoulder 42 formed on the right side edge defines an indicating portion of the page associated with the respective secondary heading. The shoulders of all of the indicating portions of a respective group of pages belonging to one secondary heading are aligned with one another so as to overlap one another when the pages of that section are closed together. Accordingly only the uppermost indicating portion of each group of pages belonging to a secondary portion is visible. The secondary marking 36 of that secondary heading is thus located on the uppermost page adjacent to and in alignment with the respective indicating portion. Due to the rows of secondary markings overlapping one another, the secondary markings of the secondary headings belonging to each primary heading are only visible when the uppermost page of that primary section is exposed by the user interacting with the indicating portions on the bottom edges of the pages relating to the primary markings.

In further embodiments, the primary and secondary headings may be interchangeably located on different edges of the book relative to the spine of the book depending upon the desired orientation of the book and depending upon which edges of the book are of greatest length for accommodating more information. Furthermore, the fourth edges of the pages may also include markings or indicating portions thereon corresponding to an additional row of secondary headings or tertiary headings which subdivide each secondary heading into additional groups of pages. Additional markings or indicating portions on the remaining edges would typically only be used on larger book sizes where the index does not occupy a substantial portion of each page.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An indexed book comprising:
a plurality of information bits organized into a hierarchal structure including a plurality of primary headings, each primary heading being subdivided into a plurality of secondary headings associated therewith, and each secondary heading including a respective group of the information bits associated therewith;
a plurality of pages comprising respective first edges bound in a common spine, respective second edges locating primary markings which represent respective ones of the primary headings, and respective third edges locating secondary markings at spaced positions therealong which represent respective ones of the secondary headings;
each page further comprising a plurality of the information bits thereon associated with one primary heading and one secondary heading;
the primary markings being arranged in at least one row in which each primary marking of said at least one row is spaced apart from the other primary markings of the row along the second edge;
each second edge further comprising an indicating portion in alignment with a respective one of the primary markings so as to associate the respective page with the respective primary heading;
the secondary markings of each primary marking being arranged in a respective row in which each secondary markings is spaced apart from the other secondary markings of the row along the third edge; and
each third edge further comprising an indicating portion in alignment with a respective one of the secondary markings so as to associate the respective page with the respective secondary heading.

2. The book according to claim 1 wherein said at least one row of the primary markings comprises a first row and a second row of primary markings.

3. The book according to claim 2 wherein a first group of the pages are associated with the first row of the primary markings and have a first overall length from an opposing edge and a second group of the pages are associated with the second row of the primary markings and have a second overall length from the opposing edge which is greater than the first overall length.

4. The book according to claim 1 wherein the second edges are opposite from the first edges such that the primary headings are opposite the common spine.

5. The book according to claim 1 wherein the first edges bound in the common spine comprise a top edge of the book and the second edges are opposite the first edges such that the primary headings are located along a bottom edge of the book.

6. The book according to claim 1 wherein the third edges are adjacent the first edges of the pages.

7. The book according to claim 1 wherein each second edge includes a first portion at a first length from the opposing edge and a second portion having a second length from the opposing edge which is less than the first length such that the first and second portions meet at a shoulder formed on the second edge which defines the indicating portion associated with the respective primary heading.

8. The book according to claim 1 wherein each third edge includes a first portion at a first length from the opposing edge and a second portion having a second length from the opposing edge which is less than the first length such that the first and second portions meet at a shoulder formed on the third edge which defines the indicating portion associated with the respective secondary heading.

9. An indexed book comprising:
a plurality of information bits organized into a hierarchal structure including a plurality of primary headings, each primary heading being subdivided into a plurality of secondary headings associated therewith, and each secondary heading including a respective group of the information bits associated therewith;
a plurality of pages comprising respective first edges bound in a common spine, respective second edges locating primary markings which represent respective ones of the primary headings, and respective third edges locating secondary markings at spaced positions therealong which represent respective ones of the secondary headings;
the first edges comprising a top edge of the book, the second edges being opposite the first edges such that the primary headings are located along a bottom edge of the book, and the third edges being adjacent the first edges of the pages;
each page further comprising a plurality of the information bits thereon associated with one primary heading and one secondary heading;
the primary markings being arranged in a first row and in a second row in which each primary marking of each row is spaced apart from the other primary markings of the row along the second edge;
a first group of the pages being associated with the first row of the primary markings and having a first overall length from an opposing edge and a second group of the pages being associated with the second row of the primary markings and having a second overall length from the opposing edge which is greater than the first overall length;
each second edge further comprising an indicating portion in alignment with a respective one of the primary markings so as to associate the respective page with the respective primary heading;
each second edge further comprising a first portion at a first length from the opposing edge and a second portion having a second length from the opposing edge which is less than the first length such that the first and second portions meet at a shoulder formed on the second edge which defines the indicating portion associated with the respective primary heading;
the secondary markings of each primary marking being arranged in a respective row in which each secondary markings is spaced apart from the other secondary markings of the row along the third edge;
each third edge further comprising an indicating portion in alignment with a respective one of the secondary markings so as to associate the respective page with the respective secondary heading; and
each third edge further comprising a first portion at a first length from the opposing edge and a second portion having a second length from the opposing edge which is less than the first length such that the first and second portions meet at a shoulder formed on the third edge which defines the indicating portion associated with the respective secondary heading.
